(19) United States
(12) Patent Application Publication
(10) Pub. No.: US 2011/0192333 A1
(43) Pub. Date: Aug. 11, 2011

(54) Stable Floating Structure wit Limited Oscillations

(76) Inventors: Theodoros Lilas, Papagou (GR); Evanthia Antoniou, Peristeri (GR); Athananos Vatistas, Peiraeus (GR); Konstantina Lila, Papagou (GR); Artemis Maglara, Zografou (GR); Nikitas Kikhtakos, Peiraeus (GR); Christos Syrseloudis, Zografou (GR)

(21) Appl. No.: 12/224,359

(22) PCT Filed: Feb. 26, 2007
(86) PCT No.: PCT/GR2007/022607

§ 371 Date: Nov. 25, 2008

(30) Foreign Application Priority Data
Feb. 24, 2006 (GR) 20060100126

(51) Int. Cl. B63B 39/02; B63B 35/44; B63B 39/03; F03D 9/00; B63B 21/24; B63J 1/00

(52) U.S. Cl. 114/122

(57) ABSTRACT

The stable floating platform is constituted from (as shown in FIG. 1) four peripheral floaters (2) and one central (1) connected to each other with tubular grid (3). On top of the central floater a metal tower (4) is supported, with a wind generator (5). In the interior of the central floater (as shown in FIG. 2) a desalination unit (6) is installed with the essential equipment, the batteries and the control equipment (7). The peripheral floaters have the ability to store and input-output water, altering in this way the natural frequency of the structure (platform), avoiding thus resonance with the sea waves. The control of the water is made with valves that feed compressed air into the compartment that contains water, regulating thus the volume of the water in the cylinders. The floating structure presents only limited oscillations under sea waves and so it is possible for the wind generator (and/or the desalination unit) to operate on it.

This invention relates to a method and a development of a stable floating platform, which is maintained steady at the effect of a wide spectrum of waves. Moreover a wind generator is installed on the platform that powers a desalination unit that is installed inside the platform.

A lot of marine applications are based on the development of floating structures, which remain stable in the sea and have installed on board all the required infrastructure for the implementation of various works.

Floating structures consist of a platform, which is supported on floaters (buoys). These floaters provide the required buoyancy and the suitable draught in the platform so that the platform with all required equipment that are installed onboard floats on the sea. The existing technology concerns mainly structures that are either supported on the seabed, or are firmly tied up with strained chains with anchors in the seabed. The basic disadvantage of existing systems is the high cost of mooring (anchoring) and the difficulty (and increased cost) to move them to other areas. Also in other floating structures the crew increases the draught in the event of bad weather conditions, in order to decrease distresses and improve the safety of the structure.

The present invention concerns the development of floating structure, which is constituted by one cylindrical central floater (buoy), four peripheral cylindrical floaters of smaller diameter connected to each other with tubes of small diameter that form a truss. The central cylinder is big enough, so that it can accommodate one desalination unit with the accompanying equipment (supply and distribution panels, batteries, control systems). The peripheral cylinders are made in such a way that they can store different water quantities. On the structure a wind generator is supported, which produces the electric power needed for the operation of the desalination and for the auxiliary equipment.

The existence of the wind generator on the platform (structure) places restrictions in the movements of the platform, so that the risk of wind generator destruction by the effect of waves is minimal.

With the present invention a method is presented, which allows the platform, to alter its characteristics depending on the wave that prevails, so that it is maintained stable for a wide range of sea waves, providing thus the wind generator with suitable conditions for safe operation.

According to the invention, the stability is achieved with the controlled import and export of water mainly in the peripheral cylinders. According to theoretical studies carried out in floating platform with the structure that was reported above, its behaviour depends on the diameter of peripheral cylinders and on their mass. In particular, the platform has longer oscillating natural period when the diameter of peripheral cylinders is minimized and their mass is increased. Selecting thus small diameter, such that it maintains the floating platform in its essential limits of stability, the present invention develops a control system for importing and exporting of water in the peripheral cylinders, which increases and decreases the mass of those cylinders, leading the platform to change its natural period. Measuring thus the period of wave that prevails in the given moment, the stability system changes with the change of water in peripheral cylinders the natural period of the platform, leading it far away from the period of the sea waves, and avoiding in such a way the resonance and achieving smaller possible oscillation. Moreover during a wave, it alters dynamically the level of water in the cylinders proportionally to the height of the wave so that the movements (oscillations) of the platform are further decreased.

The present invention presents enough advantages against the already existing structures (platforms). Most platforms are either fixed to the seabed, or are placed near the coast because they do not have good stability. Others are well tied up with chains and anchors to the sea bottom. These all have as a consequence a big cost for mooring and anchoring the platform, and a major difficulty to move the platform to other places. The particular platform (of this invention) can be placed out in the sea (floating) and can also be transported (towed) in other places easily, if and when we want, because it does not need to be very well fixed to the seabed, but can only be anchored with simple anchors (as with conventional ships). Moreover the control of stability is made automatically without the presence of personnel.

The invention is described below with the help of an example and with reference to the attached drawings.

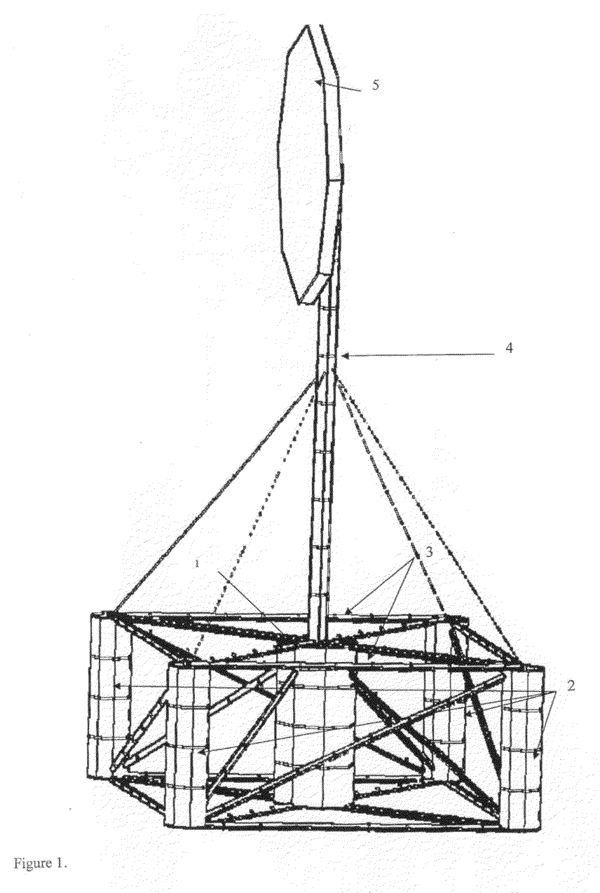

In FIG. 1 appears the floating platform with the wind generator and the tower on which the wind generator is placed.

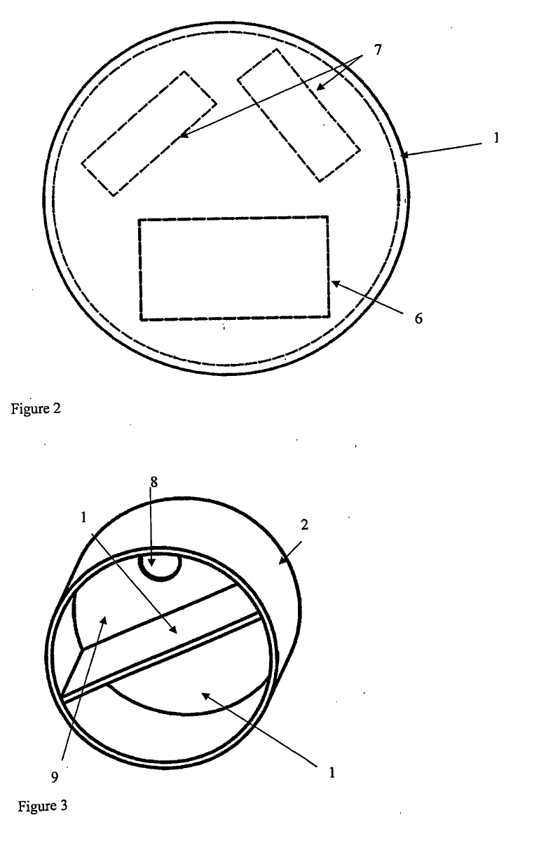

In FIG. 2 appears also the central cylinder which is made in such a way that the desalination unit (6) with the auxiliary equipment—that is to say the control panels the batteries (7) and the reservoir of potable water in its lower part—are placed inside (the cylinder).

In FIG. 3 a section of a peripheral cylinder is presented where it is shown its separation in two parts (9) and (10) by partition (11). In the department (9) there exists a hole (8) in the bottom, which allows the import and export of sea water. Department 10 remains waterproof and empty, so as to ensure a down limit in the buoyancy that the structure requires.

The import of water from the hole (8) is controlled with a compressed air system, which determines also the quantity of water that each cylinder should contain in order to achieve and maintain the essential stability of the platform. Thus with the compressed air control valve when we decrease the air pressure in the interior of the department (9) more water enters in the department from the hole (8) and in this way the period of platform increases. On the contrary when the valve increases the pressure of air in the interior of department (9) then the water comes out from the hole (8) to the sea and so less water exists in the interior of the cylinders. This has as a consequence the reduction of period of platform. The whole process includes the existence of a control computer, with the suitable software which with appropriate sensors will get data of the period of sea waves and the pressure in the interior of department (9) and will regulate the pressure of air in order to achieve the suitable volume of water and suitable natural period of the platform. Also the compartments of compressed air are connected via the controlled valves depending on the direction of the wave. Via the movement of air the mass of water in the cylinders are altered dynamically during a wave, which results in achieving smaller oscillations.

1. Method for restricting oscillations to safe levels in floating structure (platform), that is constituted from four peripheral cylindrical floaters (buoys) (2) and one central (1) which are connected to each other with tubular grid (3). It is characterized by the possibility to alter the natural period of the floating structure via the change of the mass of the peripheral cylinders relatively to the central cylinder (with or without change of draught) and its behaviour is invariant to the direction of wind and waves due to symmetrical moment of inertia as opposed to a system with 3 peripheral floaters.

2. The method for restricting oscillations in safe levels in floating structure (platform) according to claim 1 that is characterized by monitoring wave sequences and the dynamic control by change of the height of the water level in the cylinders in a twofold way (a) reacting on coming waves by modifying natural period, and (b) fast reactions against single dangerous wave during wave passing, so that the movements caused by the waves are kept in safe levels.

3. Method for restricting oscillations to safe levels of floating structure, according to claim 1, that is characterized on henceforth by utilization of the tubular design to flow water inside the tubes around the structure to utilize gyroscopic effects to stabilize the floating structure.

4. The method for restricting oscillations in floating structure (platform) according to claim 1 that is characterized from the control of the water level in the cylinders, via compressed air for the quick response of the system and the reduction of inertia compared to methods of communicating vessels.

5. Floating and stable structure (platform) with limited oscillations, that is constituted from four peripheral floaters (cylinders) (2) and one central (1) that are connected to each other with tubular grid (3). It is characterized by the existence of means that allows the change of mass of peripheral segments (floaters) and consequently the change of distribution of the masses between central and peripheral cylinders, without essential change of the draught of the floating structure, and in this way the moment of inertia is altered and consequently the natural period of the floating structure, and the restriction of dangerous oscillations due to it is achieved. Its behaviour is invariant to the direction of wind and waves due to symmetrical moment of inertia as opposed to a system with 3 peripheral floaters.

6. The floating and stable structure (platform) according to claim 5 that is characterized by utilization of the tubular design to flow water inside the tubes around the structure to utilize gyroscopic effects to stabilize the floating structure.

7. The floating and stable structure (platform) according to claim 5 is characterized from the fact (as shown in FIG. 3) that the peripheral cylinders have a vertical separating wall (11) in their centre and have also a suitable hole (8) in the bottom of department (9), so that the import and export of water in their interior is possible, and from the existence of an automatic control system with compressed air, that controls the movement of the water in the interior (9) of the peripheral cylinders. The control is made through suitable valves and control computer and leads thus to (a) the change of the natural frequency of the platform, improving thus its stability and (b) reacting during the passing of a possibly dangerous wave.

8. The floating and stable structure (platform) according to claim 3 is characterized moreover (as shown in FIG. 1) by the existence on it (on the central cylinder (1)), of one tower (4) and a wind generator (5) of suitable size and power, while in the interior of the central cylinder (as shown in FIG. 2) is installed a desalination unit (6) with its essential equipment such as control panel and batteries (7), and from the possibility of the operation of the wind generator on this, because the platform oscillates bellow operation limitations because the control system reacts and avoids possible dangerous conditions under the effect of sea waves.

9. Application of structure according to claim 5 in floating systems that use a wind generator which is placed on the floating structure and its operation is additionally stabilized by chain anchoring starting from each peripheral floater.

10. Application of the structure according to claim 5 in floating systems that use wind generator which supplies desalination units (with reverse osmosis) or other equipment which are placed onboard the floating structure or onshore and the operation is feasible because the floating structure oscillates bellow operation limitations because the system adjusts and avoids possible dangerous conditions under the effect of sea waves.

11. Method for restricting oscillations to safe levels of floating structure, according to claim 2, that is characterized on henceforth by utilization of the tubular design to flow water inside the tubes around the structure to utilize gyroscopic effects to stabilize the floating structure.

12. The method for restricting oscillations in floating structure (platform) according to claim 2 that is characterized from the control of the water level in the cylinders, via compressed air for the quick response of the system and the reduction of inertia compared to methods of communicating vessels.

13. Application of structure according to claim 6 in floating systems that use a wind generator which is placed on the floating structure and its operation is additionally stabilized by chain anchoring starting from each peripheral floater.

14. Application of structure according to claim 7 in floating systems that use a wind generator which is placed on the floating structure and its operation is additionally stabilized by chain anchoring starting from each peripheral floater.

15. Application of the structure according to claim 6 in floating systems that use wind generator which supplies desalination units (with reverse osmosis) or other equipment which are placed onboard the floating structure or onshore and the operation is feasible because the floating structure oscillates bellow operation limitations because the system adjusts and avoids possible dangerous conditions under the effect of sea waves.

16. Application of the structure according to claim 7 in floating systems that use wind generator which supplies desalination units (with reverse osmosis) or other equipment which are placed onboard the floating structure or onshore and the operation is feasible because the floating structure oscillates bellow operation limitations because the system adjusts and avoids possible dangerous conditions under the effect of sea waves.
